(19) United States
(12) Patent Application Publication
(10) Pub. No.: US 2020/0236899 A1
(43) Pub. Date: Jul. 30, 2020

(54) FEEDING VESSELS AND FEEDING VESSEL SHEILDS

(71) Applicant: Whitney MARSHALL, New York, NY (US)

(72) Inventor: Whitney MARSHALL, New York, NY (US)

(21) Appl. No.: 16/750,943

(22) Filed: Jan. 23, 2020

Related U.S. Application Data
(60) Provisional application No. 62/796,908, filed on Jan. 25, 2019.

(51) Int. Cl. A01K 5/01

(52) U.S. Cl. CPC A01K 5/0135; A01K 5/0128

(57) ABSTRACT

A feeding vessel assembly, having a feeding bowl having a cavity to receive food and water and a rim defining an upper edge of the feeding bowl, a deformable shield which can be detachable from the feeding bowl rim or edge wherein the shield when installed encloses up to about 75 percent of the circumference of the top rim thus providing an opening for an animal to access the feeding bowl cavity, wherein the shield extends from the rim of the feeding bowl to a height of about 12 inches from the floor, and wherein the shield flares outwardly from the rim of the feeding bowl as it extends upwardly in the range of about 1 to 30 degrees and is configured to allow an animal to push food up an inside wall of the shield so that it can slide into its mouth when it opens its mouth.

### CROSS-REFERENCE TO RELATED APPLICATION

This application claims priority from U.S. Provisional Patent Application 62/796,908 filed Jan. 25, 2019, which is hereby incorporated herein by reference in its entirety for all purposes.

### FIELD

Presented herein are feeding vessels and feeding vessel accessories, and in particular, feeding vessels and feeding vessel accessories with a shield to prevent food spillage.

### BACKGROUND

Various vessels have been devised to contain food, in either solid or liquid form. Such vessels are usually sized and shaped to allow an animal, such as a pet, to easily feed from the vessel. Such vessels are normally sized and shaped to be no bigger than is needed to accommodate the animal for which the vessel is designed. One of the problems of this type of design is that it does not address an animal's lack of awareness of the spillage from the vessel while feeding.

Some rudimentary efforts are known in the art to address this matter such as found in U.S. Pat. No. 1,079,261 to Park (for birds): U.S. Pat. No. 8,286,589 to Tsengas (attachable cover); GB2404834A to Weideger (small short collar); and US Pub. 20050211190 to (guard to hold back ears of floppy eared dog). Other devices include large elevated housings for multiple feeding vessels, such as one sold under the tradename NEATER FEEDER EXPRESS PET BOWLS by Neater Pet Brands (neaterpets.com/neater-feeder).

Accordingly, while food vessels and some rudimentary food vessel shields are known, there remains a desire and a need in the art to provide a vessel or a detachable vessel accessory to reduce food spillage while a pet feeds from the vessel with minimal increase in floor footprint and expense.

### SUMMARY

Accordingly, to advance at least the aforementioned deficiencies in the art, described herein are feeding vessels and feeding vessel accessories, and in particular, feeding vessels and feeding vessel accessories with a shield to prevent food spillage.

According to one approach, a feeding vessel assembly, is provided having a feeding bowl having a cavity to receive food and water and a rim or blunt edge defining an upper edge of the feeding bowl, a deformable shield which is detachable from the feeding bowl rim wherein the shield when installed encloses up to about 75 percent of the circumference of the top rim thus providing an opening for an animal to access the feeding bowl cavity, wherein the shield extends from the rim of the feeding bowl to a height of about 12 inches from the floor, and wherein the shield flares outwardly from the rim of the feeding bowl as it extends upwardly in the range of about 1 to 30 degrees and is configured to allow an animal to push food up an inside wall of the shield so that it can slide the food into its mouth when it opens its mouth. It is noted though that the height can be higher depending on the size of the animal. For example, the shield may need to be higher for a golden retriever than it would be for a pug.

In this approach, the assembly may also include a pad having an opening to receive a base of the feeding bowl and a food dispenser which is configured to dispense food into a side feeding bowl. The shield can be formed from a deformable plastic, rubber, cardboard, combinations thereof, and the like.

According to another approach, a feeding vessel assembly may have a feeding bowl having a cavity to receive food and water, a integral shield extending above the feeding bowl cavity wherein the shield encloses up to about 75 percent of the circumference of the top rim thus providing an opening for an animal to access the feeding bowl cavity, wherein the shield extends to a height of about 12 inches from the floor, and wherein the shield flares outwardly from the feeding bowl cavity as it extends upwardly in the range of about 1 to 30 degrees and is configured to allow an animal to push food up an inside wall of the shield so that it can slide into its mouth when it opens its mouth.

According to another approach, a shield for a feeding bowl is provided having a trimmable and deformable shield wall having an adhesive layer to attach to contours of an interior wall of a feeding bowl cavity; the shield configured to, when installed on the feeding bowl, extend above the feeding bowl cavity wherein the shield encloses up to about 75 percent of the circumference of a top rim of the feeding bowl thus providing an opening for an animal to access the feeding bowl cavity, wherein the shield extends to a height of about 12 inches from the floor or from the height of the bowl (i.e., it could add additional height to the already existing bowl, and wherein the shield flares outwardly from the feeding bowl cavity as it extends upwardly in the range of about 1 to 30 degrees and is configured to allow an animal to push food up an inside wall of the shield so that it can slide into its mouth when it opens its mouth.

An optional feature of the present embodiments is to provide a disposable liner configured to line the interior cavity of the feeding bowl.

Other features will become more apparent to persons having ordinary skill in the art to which the assemblies pertain and from the following description and claims.

### BRIEF DESCRIPTION OF THE DRAWINGS

FIG. 1 is a perspective view of a feeding vessel assembly including an exemplary shield, according to the present invention;

FIG. 2 is an exploded perspective view of a feeding vessel assembly including an exemplary shield, according to the present invention of FIG. 1;

FIG. 3 is a top view of a feeding vessel assembly including an exemplary shield, according to the present invention of FIG. 1;

FIG. 4 is a front view of a feeding vessel assembly including an exemplary shield, according to the present invention of FIG. 1;

FIG. 5 is a cross-sectional front view of a feeding vessel assembly including an exemplary shield, according to the present invention of FIG. 1 taken along lines V-V in FIG. 1;

FIG. 6 is a side view of a feeding vessel assembly including an exemplary shield, according to the present invention of FIG. 1;

FIG. 7 is a cross-sectional side view of a feeding vessel assembly in use including an exemplary shield, according to the present invention of FIG. 1 taken along lines VII-VII in FIG. 1;

FIG. 8 is a perspective view of another feeding vessel assembly including an exemplary shield, according to the present invention;

FIG. 9 is an exploded perspective view of a feeding vessel assembly including an exemplary shield, according to the present invention of FIG. 8;

FIG. 10 is a front view of a feeding vessel assembly including an exemplary shield, according to the present invention of FIG. 8;

FIG. 11 is a cross-sectional front view of a feeding vessel assembly including an exemplary shield, according to the present invention of FIG. 8 taken along lines XI-XI in FIG. 8;

FIG. 12 is a perspective view of another feeding vessel including an integral exemplary shield, according to the present invention;

FIG. 13 is a front view of a feeding vessel including an exemplary shield, according to the present invention of FIG. 12;

FIG. 14 is a cross-sectional front view of a feeding vessel including an exemplary shield, according to the present invention of FIG. 12 taken along lines XIV-XIV in FIG. 12;

FIG. 15 is a side view of a feeding vessel assembly including an exemplary shield, according to the present invention of FIG. 12;

FIG. 16 is a cross-sectional side view of a feeding vessel assembly in use including an exemplary shield, according to the present invention of FIG. 12 taken along lines XVI-XVI in FIG. 12;

FIG. 17 is a perspective view of another feeding vessel including an exemplary shield, according to the present invention;

FIG. 18 is a perspective view of an exemplary feeding vessel shield, according to the present invention;

FIG. 19 is a perspective view of another feeding vessel assembly including the exemplary shield of FIG. 18, according to the present invention;

FIG. 20 is an exploded perspective view of another feeding vessel assembly including the exemplary shield of FIG. 18, according to the present invention of FIG. 19;

FIG. 21 is a side view of a feeding vessel assembly including an exemplary shield, according to the present invention of FIG. 19;

FIG. 22 is a front perspective view of another feeding vessel including an integral exemplary shield, according to the present invention;

FIG. 23 is a side, elevational view of a cross section of the feeding vessel including an integral exemplary shield of FIG. 22;

FIG. 24 is a front perspective view of a disposable liner for a feeding vessel according to the present invention; and

FIG. 25 is a front perspective view of a disposable liner for a feeding vessel according to the present invention.

FIG. 26 is a front perspective view of a disposable ramp/liner for a feeding vessel according another approach.

FIG. 27 is a front planar sectional view of a disposable ramp/liner for a feeding vessel according to FIG. 26.

FIG. 28 is a front perspective view of an optional disposable wedge and protective cover for a feeding vessel according to one approach to the present invention.

FIG. 29 is a side planar sectional view of the optional disposable wedge and protective cover according to FIG. 28.

FIG. 30 is a side planar sectional view of an optional protective cover.

FIG. 31 is a side planar sectional view on an injection molded feeding vessel according to another approach.

FIG. 32 is a front perspective view of a feeding vessel according another approach configured to receive a feed bowl.

FIG. 33 is a side planar sectional view of the optional disposable wedge and protective cover according to FIG. 28 elevated above the bottom of the bowl.

FIG. 34 is a side planar sectional view of the optional disposable wedge and protective cover according to a feeding vessel according to one approach to the present invention having a hook and the protective cover having openings to receive the hook.

FIG. 35 is a front perspective view of a disposable ramp/liner for a feeding vessel according another approach having a hook.

FIG. 36 is a front planar sectional view of a disposable ramp/liner for a feeding vessel according to FIG. 35, with the feeding vessels having openings to receive the hook.

FIG. 37 is a side planar sectional view of the feeding vessel of FIG. 38 taken along section line XXXVII-XXXVII of FIG. 38.

FIG. 38 is a perspective view of an optional disposable wedge to a feeding vessel according to one approach to the present invention having a wedge hook and the feeding vessel having openings to receive the wedge hook. FIG. 39A is a side view of a wedge according to another approach.

FIG. 39A is a side view of a wedge according to another approach.

FIG. 39B is a side view of a wedge according to another approach.

FIG. 39C is a side view of a wedge according to another approach.

FIG. 39D is a side view of a wedge according to another approach.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

Many animals, such as household pets, including but not limited to cats and dogs, often eat and drink out of vessels or bowls made for human use or bowls that have a similar shape to bowls made for human use. For many animals, use of such bowls results in food or water spilling over the sides of the bowl because the animal uses the side of the bowl to help get food/water into its mouth. Also, just normal head motions of the animal can lead to spillage because the sides of the bowl are not tall enough.

Keeping food in bowls is particularly difficult for flat-faced breeds of cats and dogs, known as brachycephalic breeds. Because they have flat faces, rather than a pointed snout, they have to rely on the sides of their feeding bowls as a surface to help them push food into their mouths. This results in food spillage and difficulty eating. The present embodiments provide food vessels and accessories that can help animals get food into their mouths and keep unconsumed food in the bowls. The present vessels are thus configured to prevent food from spilling out of the bowl and to assist animals to get food into their mouths.

According to one approach of the present embodiments, a bowl is provided having an elongated back and sides. The front of the bowl is lower than the back and sides of the bowl. The front of the bowl is high enough to contain dry or wet food, preventing the food from spilling onto the floor. The back and sides of the bowl are configured to be high enough to allow an animal to push their food around during consumption without spillage. In one embodiment, the back and sides can be approximately twelve inches high, but may be higher to conform to the intended animal breed for the vessel. The height of the sides should be close to the height of the animal's shoulders when sitting upright—because that is the height of the animal's head when it comes up from scooping food into their mouths.

The bottom of the bowl can be flat or rounded. The back and/or sides of the bowl may be straight or slanted towards the front of the bowl and create a funnel effect by tilting the back and sides towards the animal's mouth. This allows the animal to push food up against the taller side surface, lift their chins, and the pull of gravity then slides/drops the food into their mouths.

The present embodiments provide several features and advantages not known in the art.

The present food vessel is not an elevated stand for multiple food bowls. In one approach, it has no removable parts (i.e., it is a bowl with high sides and a high back). The tall back and sides of the present embodiments may also be slanted towards the center of the bowl (instead of being vertical). Also, the sides and back are all the same height, rather than slanted towards the front of the bowl, such as one where the sides are slanted lower in height than the back as it approaches the front of the vessel. The present embodiments do not have an automatic closure in the front that can be easily opened by the animal; nor does it have a cover at the top.

The present embodiments may be formed from a variety of materials. If the bowl is one piece including the shield, it can be made from a variety of materials such as plastic, various metal compositions (e.g., stainless steel, and the like), glass, ceramic, stoneware, silicone, acrylics, wood, deformable compositions (e.g., rubber), and the like. The present embodiments and any of its optional components may be clear (transparent) or various degrees of opaqueness/translucence in any combination. Optional features can include a rubber layer (or a tacky/sticky/adhesive base material) on the bottom surface to reduce sliding on the floor when in use. Optionally, the present embodiments may also include weights in the bottom to prevent the bowl from tipping over if the vessel is not made of a heavy material.

According to one approach where a prior art vessel is provided, a detachable shield can be provided. The shield could be configured to stand at least 12 inches off the floor or the bowl when installed in the food vessel. The detachable shield may be made of a material that is flexible and can take on the shape of the food vessel and allow attachment to the rim of the vessel. Such materials may include plastic, metal, or any flexible/deformable material. Even though the material is deformable, it must be remain upright while in use (i.e., when the animal is feeding from the vessel) and strong enough that it will not fold over if the animal pushes their face up against it when getting food into their mouths.

The detachable shield may be attached to the already-existing food bowl with an adhesive (removable/pressure sensitive adhesive or permanent adhesive), a suction cup configuration (i.e., a user wets the material and it retains a suction force to remain adhered to the vessel), clips, hook and loop fasteners (such as one sold under the tradename VELCRO), or has a lip shaped to match the rim of the feeding vessel to allow it to snap into place. The detachable shield may be attached on the inside of the bowl or on the outside of the bowl. Attachment inside the bowl would be preferred to reduce potential gaps of space between the food bowl and the shield and would allow the wall of the vessel to provide support to the shield when in use. The detachable shield can be disposable and formed from a variety of deformable materials such as plastic, paper (e.g., cardboard), rubber, and the like.

The detachable shield may be adjustable/trimmable to adjust to the diameter of the food bowl already owned. The adhesive would provide a snug fit to the sides of the bowl so food cannot fall in between the holder and the bowl.

Accordingly, the present embodiments provide a shied that should be at least 12 in. high all the way around, except for the front of the bowl (so the animal can walk up to the bowl and stick their head into the food). The tall shield does not go around the entire circumference of the bowl, but rather approximately ¾ around the bowl, leaving part of the bowl without a shield so the animal's face will be able to access the food in the bowl.

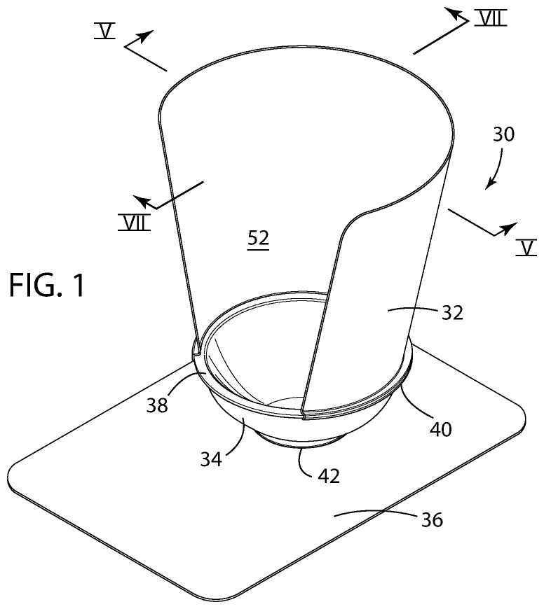

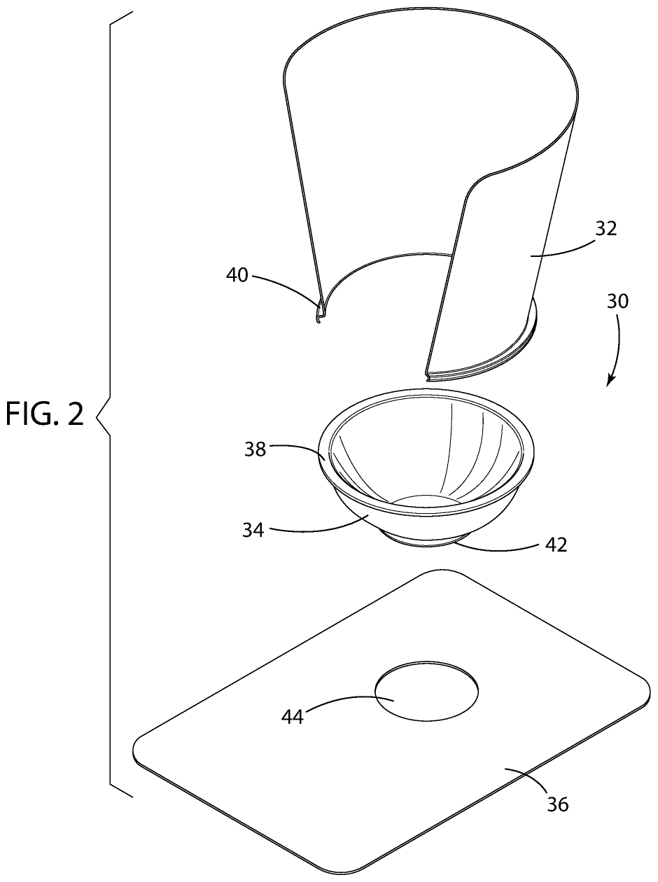

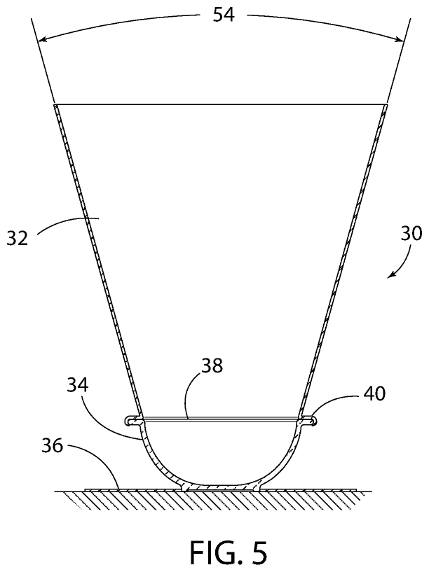

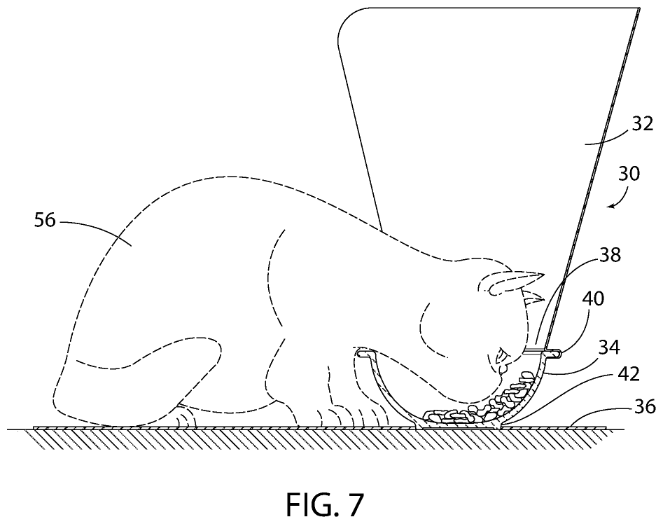

Turning to the figures, FIGS. 1-7 show one approach to the present embodiments. A feeding Vessel Assembly 30 can have a shield/collar/apron (“shield”) 32, which is detachable from a feeding vessel 34. Shield 32 can attach to a feeding vessel rim 38 by a deformable shield lip configured to match feeding vessel rim 40. A non-skid pad 36 can optionally be provided to reduce sliding of the animal and/or the feeding vessel while in use and to also keep a pet owner's floor clean. A feeding vessel bottom flange 42, which can also include weights to stabilize the assembly further, can be configured to be received by a pad opening 44. Pad opening 44 can be configured to receive a portion (including all) of feeding vessel bottom flange. Weight can range up to about 3 or 4 pounds. As mentioned herein, the shield does not cover the entire circumference of the rim of feeding vessel 34, but is provided with an opening 52 to allow an animal 56 to access the contents of the feeding vessel. As shown in FIGS. 4 and 5 a lower shield opening 46 can be in the range of 30-180 degrees; upper shield opening 48 can be in the range of 30-180 degrees; side taper 50 of shield 34 can be in the range of −45 to 80 degrees. A shield opening flare 54 can be in the range of −45 to 170 degrees (preferably about 30 to 90 degrees and most preferably about 35 degrees), and a shield taper 58 can be in the range of −45 to 170 degrees (preferably about 30 to 90 degrees and most preferably about 35 degrees). It is noted that within this range, the shield can be vertical.

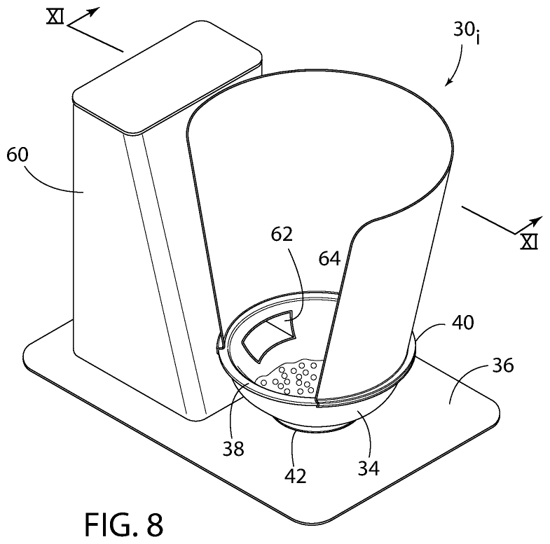

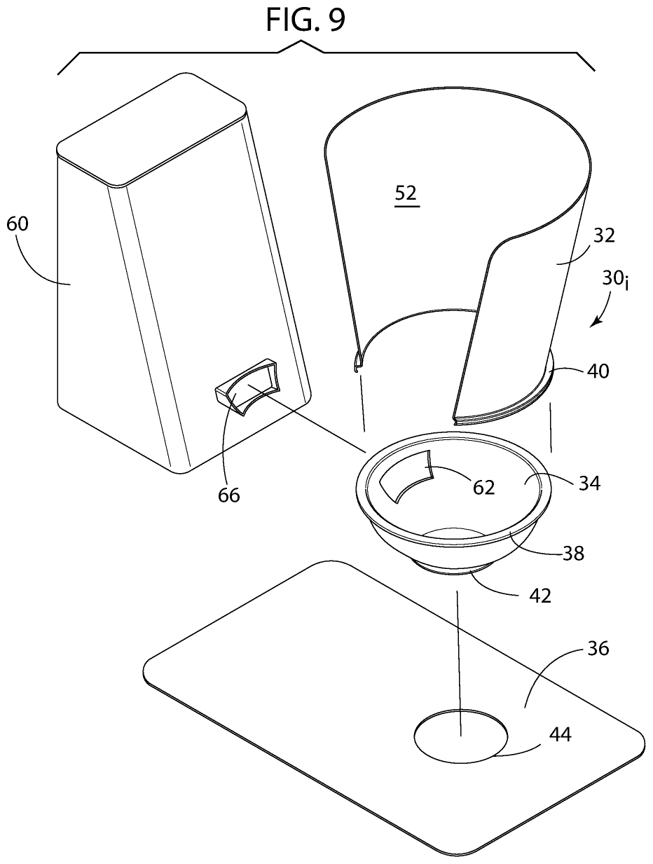

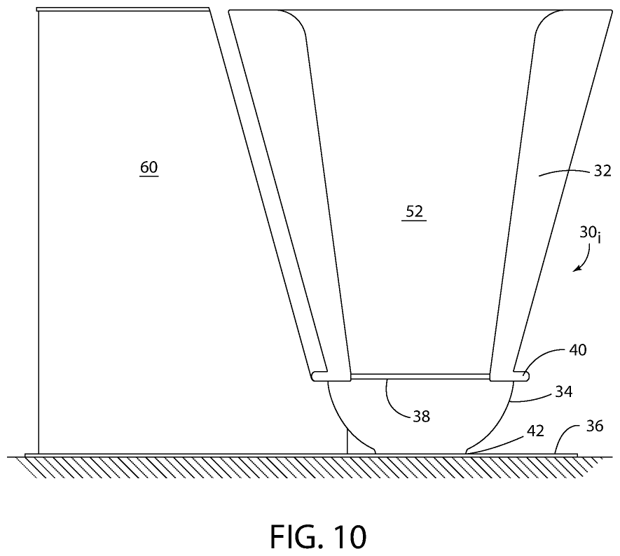

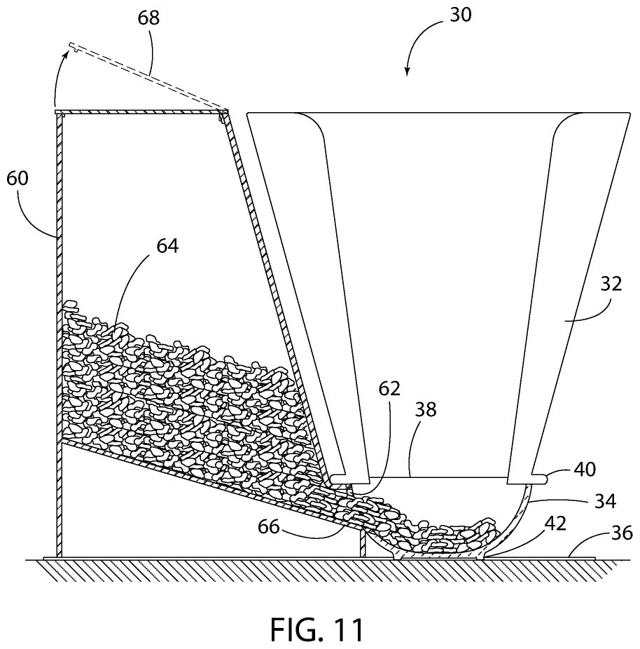

FIGS. 8-11 show another approach to the present embodiments. In this assembly, an optional food dispenser 60 is provided having a feeding vessel opening 62 to receive food from food dispenser opening 66 (FIG. 9). Here feed/food/liquid 64 can travel through food dispenser opening 66. FIG. 11 shows a food dispenser top hinged lid 68.

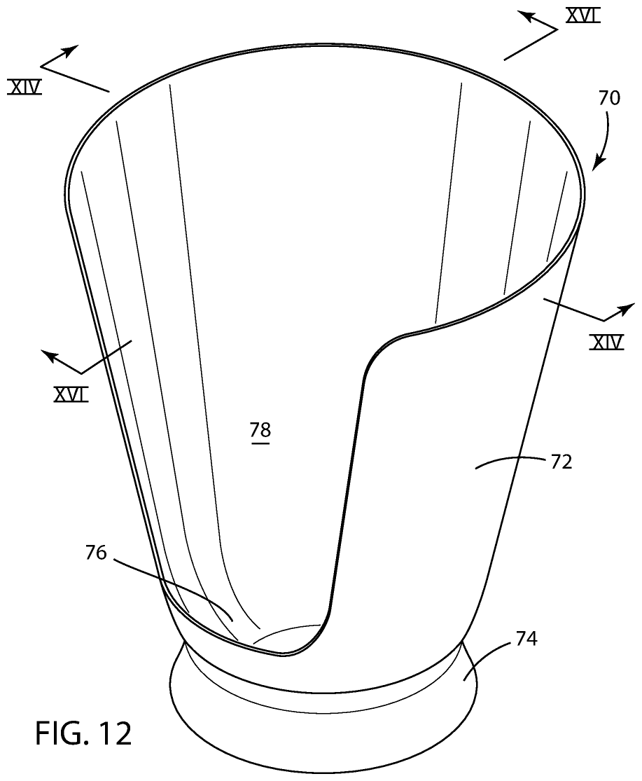

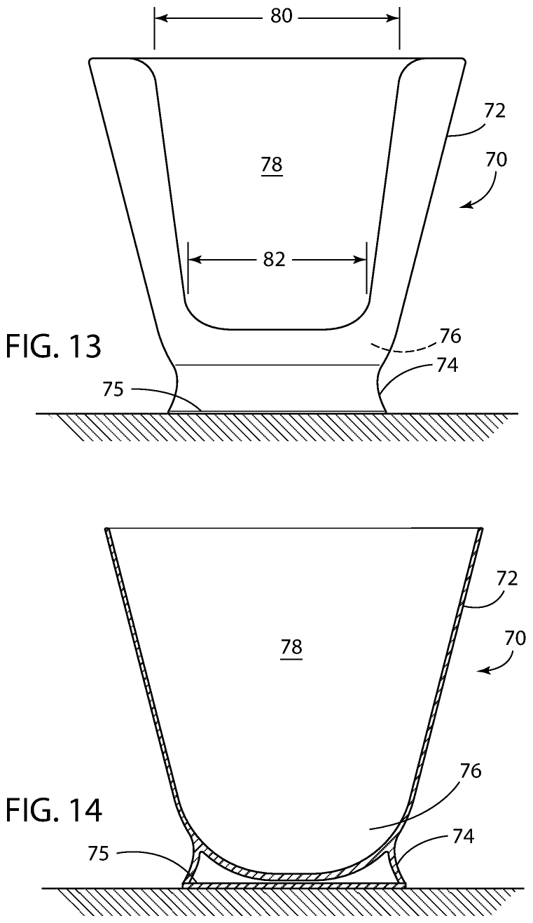

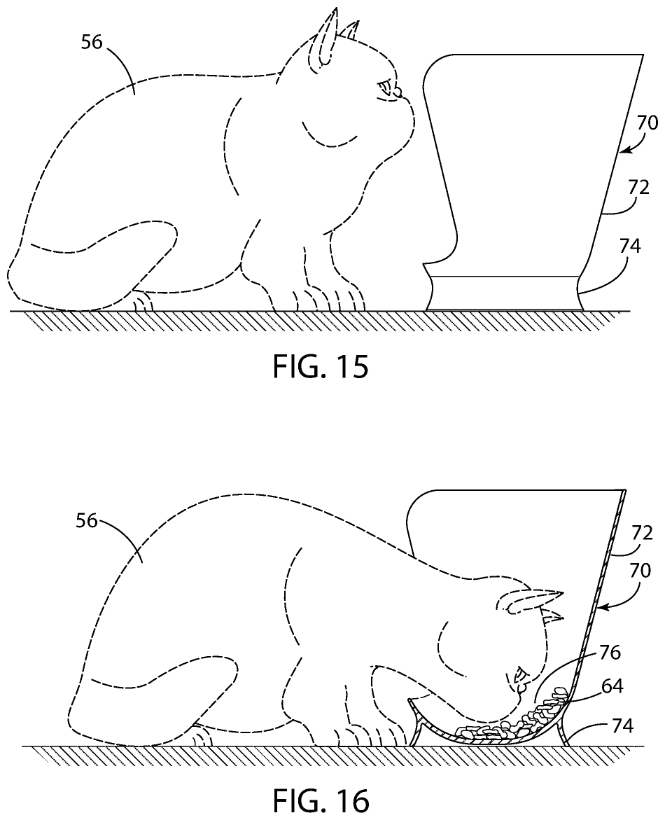

FIGS. 12-16 show another approach to the present embodiments. In this assembly a feeding vessel 70 as an integrated shield 72 and a base 74. An optional rubber layer or other adhesive or antiskid layer 75 can be supplied where the base meets the floor. It is noted though that any of the embodiments described herein can have this antiskid feature. Feeding vessel 70 has a cavity to receive food/liquids 76 and an opening 78 for the animal to access the contents of the cavity. In this one piece embodiment, top opening dimension 80 and bottom opening dimension 82 can be in the proportional ratio ranges of 1:2 to 1:1 to 2:1 (i.e., the top can be in the range of half or double the dimension of the top opening dimension).

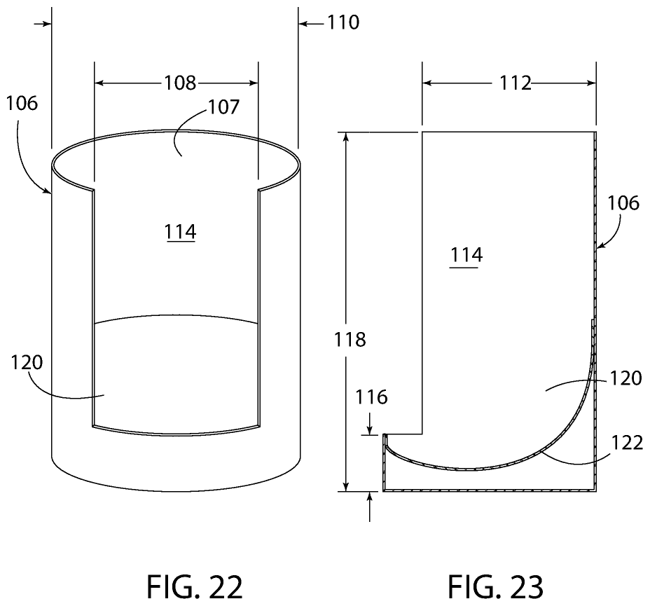

FIG. 17 shows another approach to the present embodiments. In this assembly a cuboid or rectilinear feeding vessel is provided having a feeding vessel with shield 84 having side shields 86, a back shield 88, and a front shield 90 to form a cavity 92 to contain food/water. In this embodiment front shield height 92 can be in the range of 10 to 90 percent of side shield height 95. As mentioned above side shield height 95 is preferably at least 12 inches above floor level. It is noted that the embodiment of FIG. 17 may also be configured in a variety of other ways, for example in the front 90 and sides (86 and 84) do not need to be planar, but could be curved toward the front so they connect to front shield 90, but still configured so that there is just enough room for the animal's head. (Cf., FIG. 22 where it could be an angular version like this, with the pieces in the front)

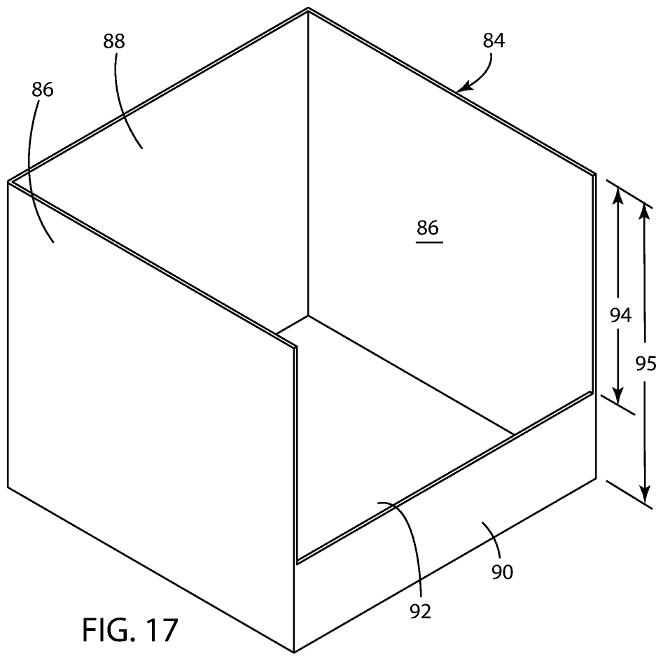

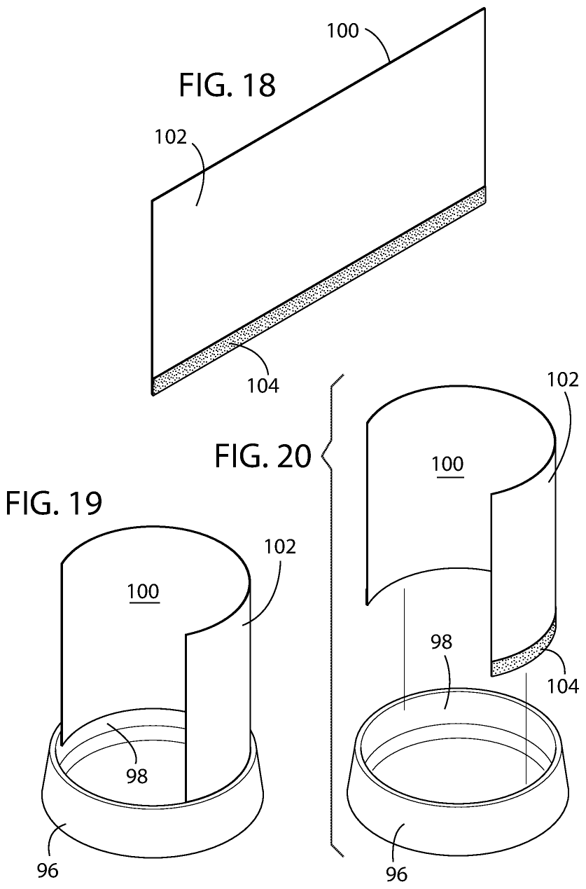

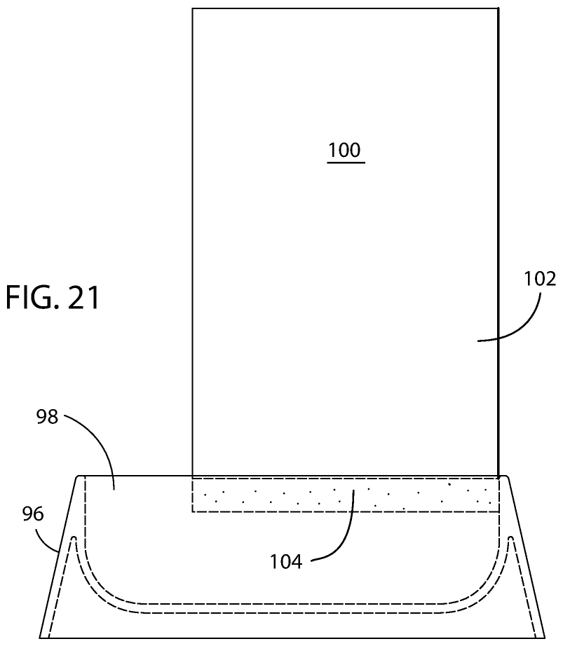

FIGS. 18-21 show another approach to the present embodiments. In this approach, an animal owner may already have a feeding vessel 96 to which the animal is accustomed. In this instance a deformable shield 100 can be provided having a shield wall 102 and an adhesive layer 104 (e.g., a pressure sensitive adhesive) to attach to the feeding vessel interior or exterior wall 98. Shield 100 can deform to match the contours of feeding vessel 96 and can be made of a material, such as a rigid but deformable plastic, rubber or cardboard that can even be trimmed to allow for an adequate opening for the animal to access the contents of the feeding vessel. It is noted that shield 100 can be cut in two (for example) to fit to the sides of an automatic feeder to prevents the shield from blocking food from being dispensed by the automatic feeder.

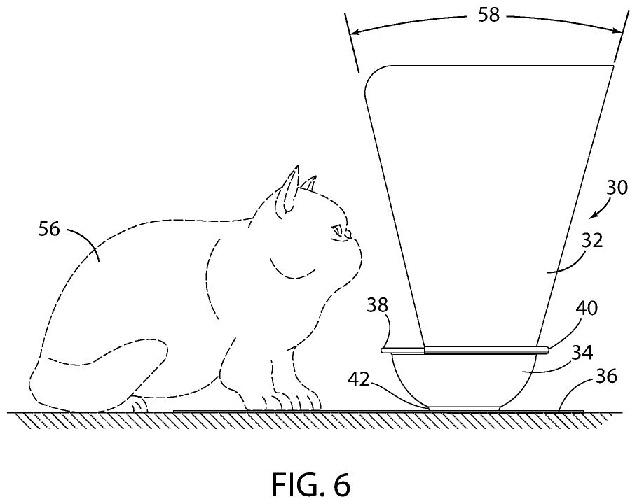

FIGS. 22 and 23 show cylindrical feeding vessel 106 including an integral exemplary shield 107, according to the present invention according to another approach. In this embodiment, the feeding vessel has an integral shield and is configured to have parallel sides 110 and parallel edges 108 to opening 114 for an animal to access the feeding vessel cavity 120. In other words, in this embodiment, the diameter 110 of feeding vessel is the same from top to bottom. Similarly, the opening 112 and feeding vessel back wall are also parallel. A front portion side height 116 can be approximately 10 percent of the height of feeding vessel and shield 118. This embodiment can also have a cavity 120 that is defined by a curved wall sloping sides as shown at 122. This shield can also be designed so that it too flares outward. It can rise vertically such as shown in the figure, but within the scope of the present embodiments some approaches can have a shield flares out like the bowls shown herein (See e.g., FIG. 6.) and have an adhesive at its bottom, such as a pressure sensitive adhesive.

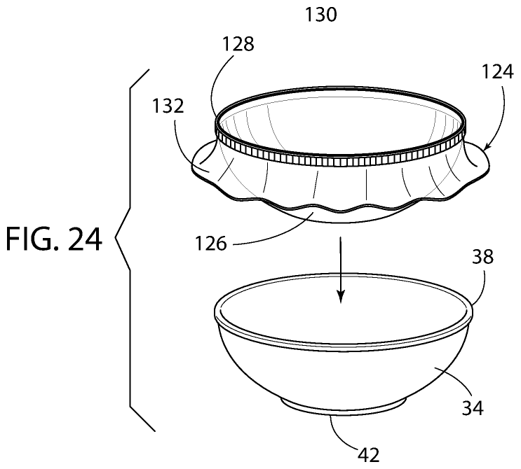

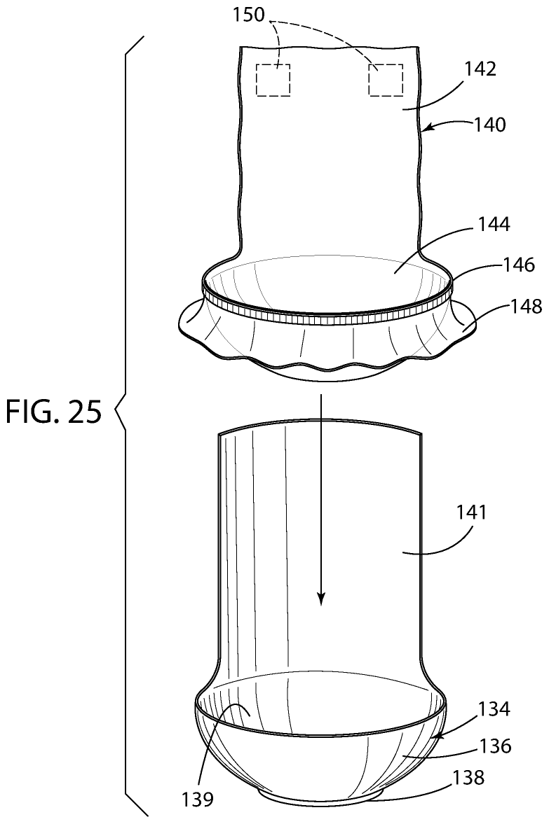

FIGS. 24 and 25 show optional disposable liners that can be applied for example to the feeding vessel of FIG. 1 prior to attaching shield 32 around vessel 34 lip 38. Also, FIG. 25 shows an exemplary liner that can be installed on, for example, the feeding vessel of FIG. 12 or as shown as feeding vessel 134.

Specifically, FIG. 24 is a front perspective view of a feeding vessel disposable liner 124 for a feeding vessel 34. Liner portion 126 is configured to line the interior cavity of the feeding vessel 34; the liner can be optional held in place by and elastic band 128 or other attachment means such as pressure sensitive adhesives, clips, hook and loop fasteners and the like. The elastic band would not be needed to hold the liner in place if it is installed prior to attaching shield 32 to feeding vessel 34 via lip 440 onto rim 38. Once installed, liner portion 130 lines the interior of vessel cavity while liner portion 132 extends beyond elastic band to allow a pet owner to allow disposal of liner material

FIG. 25 is a front perspective view of a for a feeding vessel according to another approach to the present invention. As shown, feeding vessel can have an integral shield 134; a feeding bowl portion 136; feeding vessel bottom flange 138; feeding vessel cavity 139; feeding vessel with integral shield disposable liner 140; liner portion to cover shield 142; liner portion to line interior of vessel cavity 144; elastic band 146; and liner portion 148 extending beyond elastic band to allow a pet owner to allow disposal of liner material. Liner portion 142 may optionally have pressure sensitive adhesive to hold the liner to the shield portion 141. The liner portion may also attach to the back shield only and one version may attach to the side shields as well. It is noted though that clips, hook and look fasteners could also be used. According to another approach, the disposable liner can conform to the embodiments of FIG. 22 and FIG. 17 that can be made from cardboard, for example, that can be placed inside an already existing bowl. It can come in small, medium, and large sizes to fit an already existing bowl or it can be adjustable. A reusable liner can also be configured according to another approach in the shape of the embodiment of FIG. 22 whereby the liner is placed into an already existing bowl and can be taken out to be cleaned.

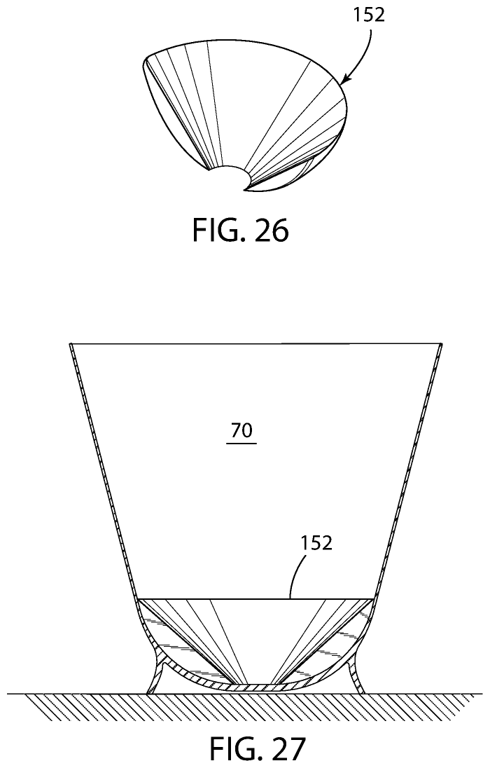

FIG. 26 is a front perspective view of a disposable ramp/liner 152 for a feeding vessel according another approach. This ramp can be added to any feeding vessel to provide an increased and removable ramp. FIG. 27 shows a planar sectional view of disposable ramp/liner 152 installed in an exemplary a feeding vessel 70.

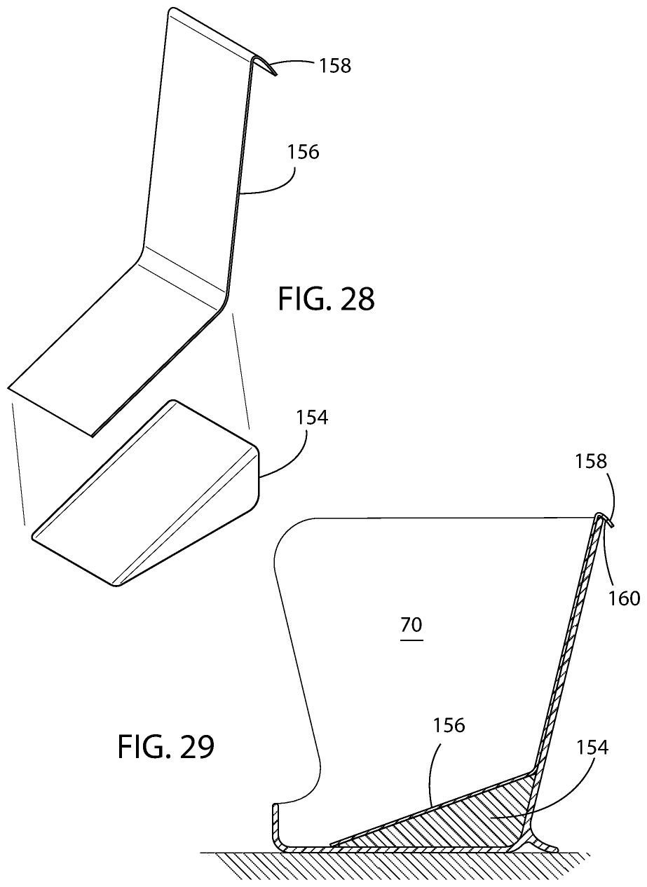

FIG. 28 shows a front perspective view of an optional disposable wedge e.g., disposable and or removable) 154 and protective cover 156 for a feeding vessel according to one approach to the present invention. As shown in FIG. 29, the optional disposable wedge 154 and optional protective cover 156 may also be placed in an exemplary feeding vessel 70 to increase the ramp angle. As shown, foldable flap 158 for the optional protective cover 156 can be wrapped over feeding vessel shield top 160.

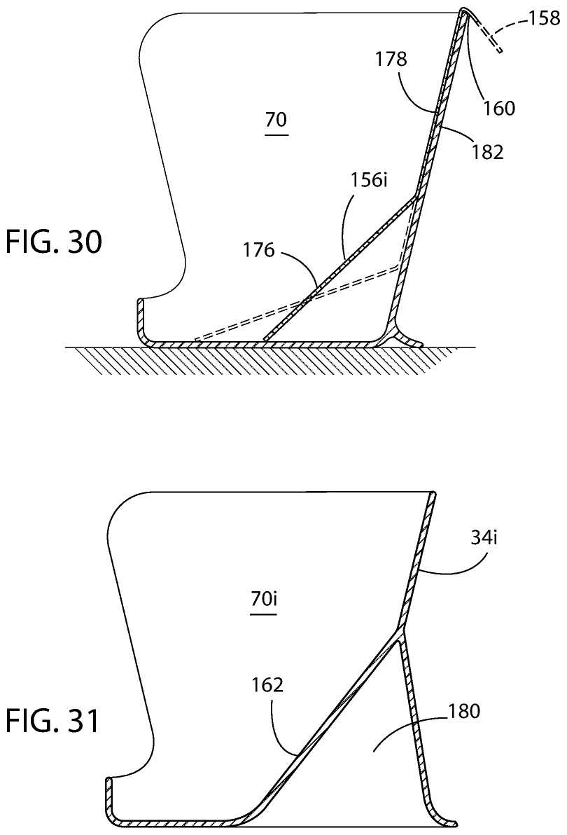

FIG. 30 is a side planar sectional view of an optional protective cover according to another approach. In this embodiment, protective cover 156i can made from rigid but deformable material (such as a thin aluminum plate (about 1 mm thick)) disposed along a back wall 182 of shield 70 that can be folded over 158 the top of shield 160. Lower portion 176 of protective cover 156i can be made from a more rigid material such as a thick aluminum plate (e.g., >1 mm) or rigid plastic or even wood. In use, a user may adjust the height and angle of lower potion 176 by lifting fold over portion 158 to the desired height and folded along the top of shield top 160.

FIG. 31 is a side planar sectional view on an injection molded feeding vessel according to another approach. In this embodiment, feeding vessel 70 can be formed by a single piece injection molding process and have a void are 180 between the outside of the vessel and integral ramp 162.

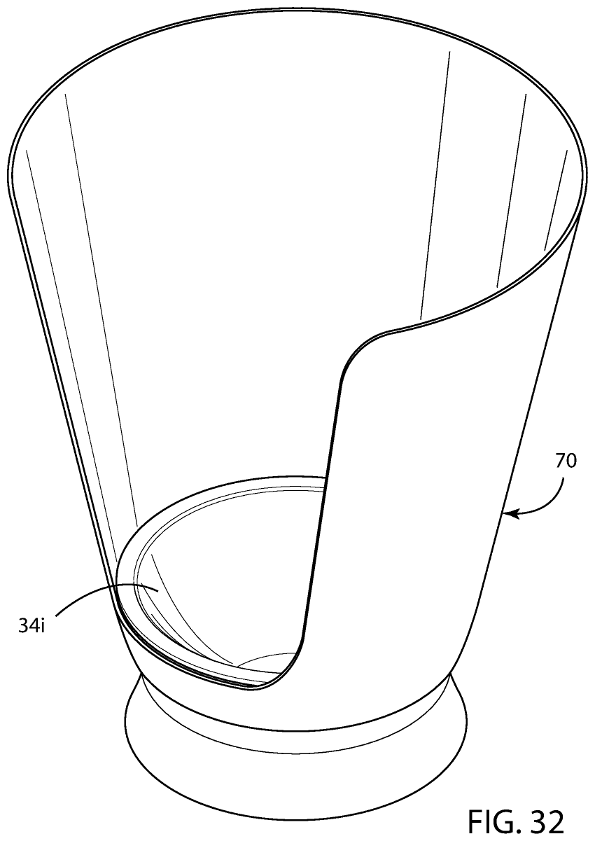

FIG. 32 shows a front perspective view of a feeding vessel according another approach. In this embodiment, a removable bowl 34i can placed within feeding vessel with shield 70. It is noted though that adding bowl 34i can be configured for placement within any of the feeding vessels.

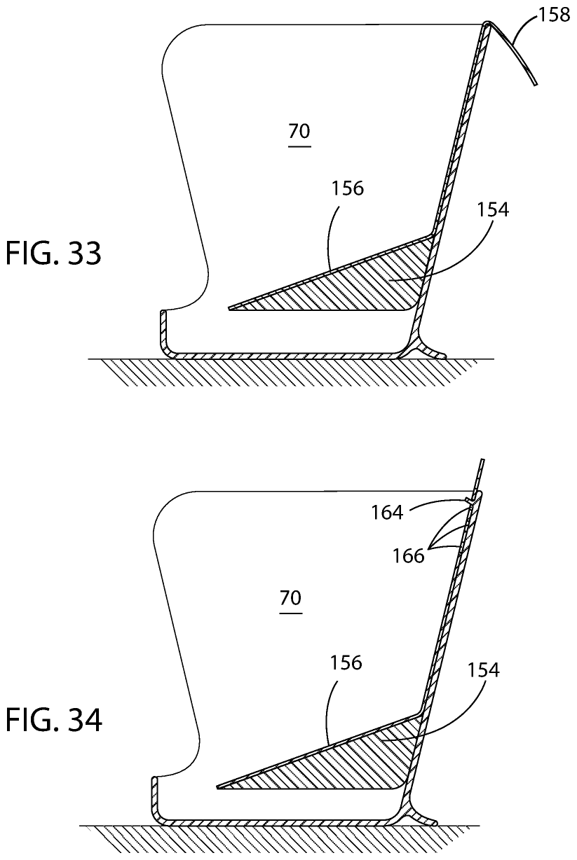

FIG. 33 is a side planar sectional view of the optional disposable/removable wedge and protective cover according to FIG. 29 elevated above the bottom of the bowl.

FIG. 34 is a side planar sectional view of the optional disposable wedge and protective cover according to a feeding vessel according to one approach to the present invention having a hook 164 and the protective cover 156 having openings 166 to receive the hook. According to this approach, the user may raise and lower wedge 154 to a desired height.

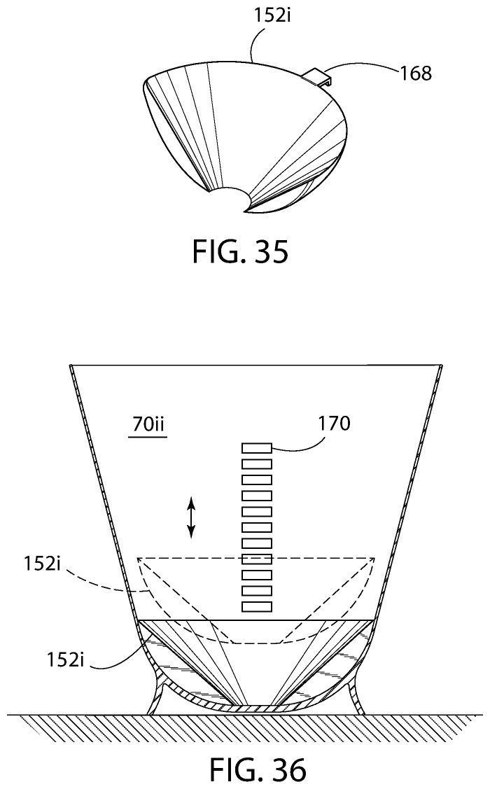

FIG. 35 is a front perspective view of a wedge 154i for a feeding vessel 70i according another approach. This ramp 152i can be added to any feeding vessel to provide an increased and removable ramp using hook 168 to any of the openings 170 of feeding vessel 70i as shown in FIG. 36.

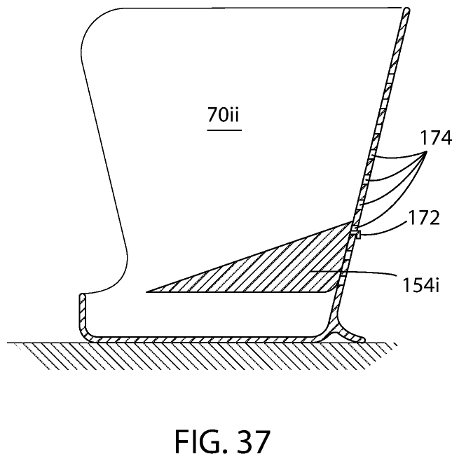

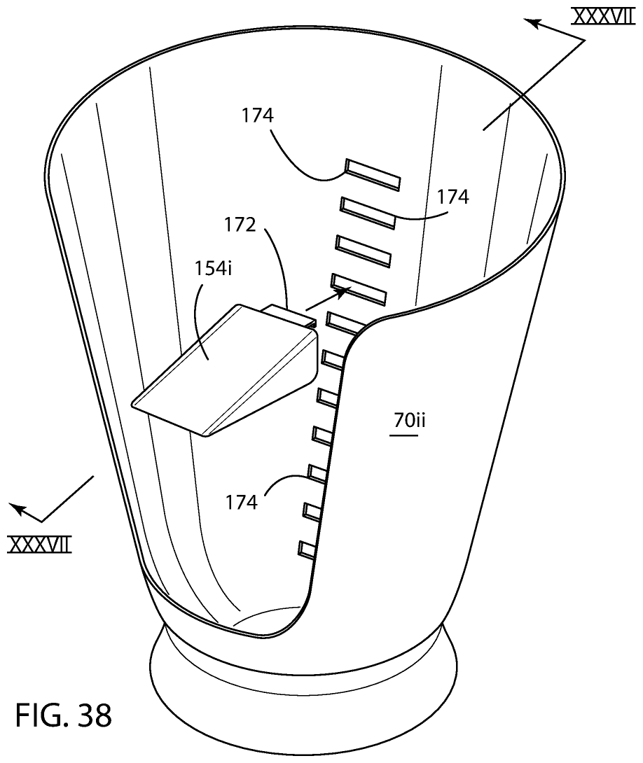

FIG. 38 is a perspective view of an optional disposable wedge 154i to a feeding vessel 70i according to one approach to the present invention having a wedge hook 172 and the feeding vessel 70i having openings 174 to receive wedge hook 172. FIG. 37 is a side planar sectional view of the feeding vessel of FIG. 38 taken along section line XXXVII-XXXVII of FIG. 38.

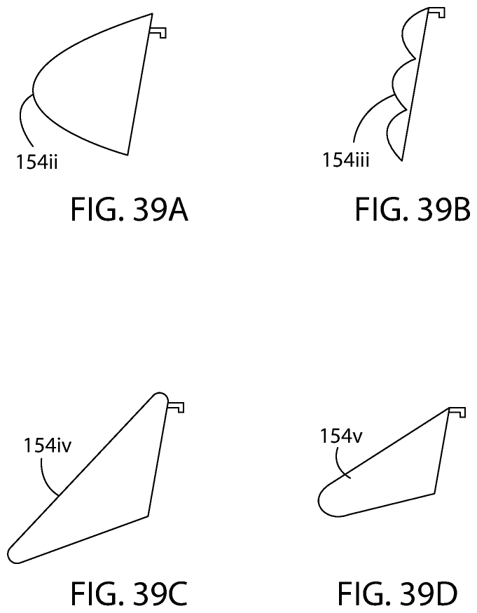

FIG. 39A-D are side views of a wedge according to other approaches. The optional hook is shown for reference, though would only be needed in those embodiments with the shield openings.

It is noted that although embodiments with the various configurations of the feeding vessel with the integral shield are not shown, it is understood that these various shield configurations would also apply to shields attachable to a feeding bowl and are therefore within the scope of the present embodiments. It is also noted that the various profiles of the wedge elements 154 can be integrally formed and stationary on the shield surface. It is also noted that the shield may have a variety of textures and compositions to add friction to the food as the animal eats. Such materials may include materials with a high coefficient of friction such as rubber or even a low tac pressure sensitive adhesive. A washboard or any of a variety of geometrical shapes (including but not limited to curves and angles) may also be used as a surface the animal uses to scrape food into its mouth.

The drawings and the foregoing descriptions are not intended to represent the only forms of the feeding vessels and accessory assemblies in regard to the details of construction. Changes in form and in proportion of parts, as well as the substitution of equivalents, are contemplated as circumstances may suggest or render expedient.

While the embodiments have been described in conjunction with specific embodiments, it is evident that many alternatives, modifications and variations will be apparent to those skilled in the art in light of the foregoing description. Accordingly, the present embodiments attempt to embrace all such alternatives, modifications and variations that fall within the spirit and scope of the appended claims. Throughout this specification and the drawings and figures associated with this specification, numerical labels of previously shown or discussed features may be reused in another drawing figure to indicate similar features.

### LIST OF REFERENCE NUMBERS

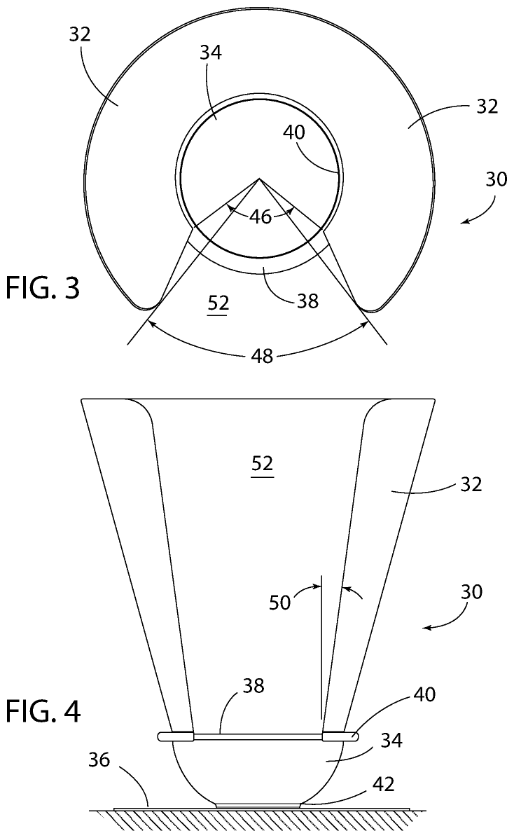

30 feeding vessel assembly according on one approach
32 shield/collar/apron (“shield”)
34 feeding vessel
36 pad
38 feeding vessel rim
40 deformable shield lip to match feeding vessel rim
42 feeding vessel bottom flange, can also include weights
44 pad opening to receive a portion (including all) of feeding vessel bottom flange
46 lower shield opening (30-180 degrees)
48 upper shield opening (30-180 degrees)
50 side taper of shield (−45 to 80 degrees including vertical)
52 shield opening
54 opening flare (−45 to 170 degrees)
56 animal
58 shield taper (−45 to 170 degrees)
60 food dispenser
62 feeding vessel opening to receive food from food dispenser 60 opening 66
64 feed/food/liquid
66 food dispenser opening
68 food dispenser top hinged lid
70 feeding vessel with shield
72 shield
74 base
75 rubber layer or other adhesive layer
76 cavity to receive food/liquids
78 opening
80 top opening dimension
82 bottom opening dimension (ratio proportions 1:2 to 1:1 to 2:1; that is the top can be half or double the dimension of the top opening dimension)
84 feeding vessel with shield
86 side shields
88 back shield
90 front shield
92 front shield height (10 to 90 percent of side shield height)
94 side shield height above front shield 90
95 total side shield height (approximately 12 inches)
96 feeding vessel
98 feeding vessel interior wall
100 shield
102 shield wall
104 adhesive (e.g., a pressure sensitive adhesive)
106 cylindrical embodiment
107 integral shield
108 opening 114 sides (parallel)
110 feeding vessel diameter (parallel)
112 opening and feeding vessel back wall—parallel
114 feeding vessel 106 opening for animal to access cavity
116 front side height approximately 10 percent of height 118
118 height of feeding vessel and shield
120 cavity
122 optional sloping sides of area to define cavity
124 feeding vessel disposable liner
126 disposable liner configured to line the interior cavity of the feeding vessel 34
128 elastic band to mount to rim 38
130 liner portion to line interior of vessel cavity
132 liner portion extending beyond elastic band to allow a pet owner to allow disposal of liner material
134 feeding vessel with integral shield
136 feeding vessel portion
138 feeding vessel bottom flange
139 feeding vessel cavity
140 feeding vessel with integral shield disposable liner
141 integral shield
142 liner portion to cover shield
144 liner portion to line interior of vessel cavity
146 elastic band
148 liner portion extending beyond elastic band to allow a pet owner to allow disposal of liner material
150 pressure sensitive adhesive
152 optional ramp
154 optional removable wedge
156 optional protective cover for optional removable wedge
158 foldable flap for optional protective cover for optional removable wedge
160 feeding vessel shield top
162 molded ramp for vessel 34i
164 shield hook
166 optional protective cover for optional removable wedge opening for shield hook
168 optional ramp hook
170 opening in shield 70 for optional ramp hook 168
172 optional removable wedge hook
174 feeding vessel shield series of openings
176 rigid portion of protective shield
178 pliable portion of shield 154i
180 void of injection mold embodiment of FIG. 3′.
182 back wall of feeding vessel 70

I claim:

1. A feeding vessel assembly, comprising:
a feeding bowl having a cavity to receive food and water and a rim defining an upper edge of the feeding bowl,
a deformable shield which is detachable from the feeding bowl rim wherein the shield when installed encloses up to about 75 percent of the circumference of the top rim thus providing an opening for an animal to access the feeding bowl cavity,
wherein the shield extends from the rim of the feeding bowl to a height of about 12 inches from the floor or the bowl, and
wherein the shield flares outwardly from the rim of the feeding bowl as it extends upwardly in the range of about 1 to 30 degrees and is configured to allow an animal to push food up an inside wall of the shield so that it can slide into its mouth when it opens its mouth.

2. The feeding vessel assembly of claim 1, further comprising,
a pad having an opening to receive a base of the feeding bowl.

3. The feeding vessel assembly of claim 1, further comprising,
a food dispenser which is configured to dispense food into a side feeding bowl.

4. The feeding vessel assembly of claim 1, wherein the shield is selected from the group consisting of deformable plastic, rubber, cardboard and combinations thereof.

5. The feeding vessel assembly of claim 1, wherein vertical ends of the shield provide an opening having vertical sides.

6. A feeding vessel assembly, comprising:
a feeding bowl having a cavity to receive food and water,
a integral shield extending above the feeding bowl cavity wherein the shield encloses up to about 75 percent of the circumference of the top rim thus providing an opening for an animal to access the feeding bowl cavity,
wherein the shield extends to a height of about 12 inches from the floor, and
wherein the shield flares outwardly from the feeding bowl cavity as it extends upwardly in the range of about 1 to 30 degrees and is configured to allow an animal to push food up an inside wall of the shield so that it can slide into its mouth when it opens its mouth.

7. A shield for a feeding bowl, comprising:
a trimmable and deformable shield wall having an adhesive layer to attach to contours of an interior wall of a feeding bowl cavity;
the shield configured to, when installed on the feeding bowl, extend above the feeding bowl cavity wherein the shield encloses up to about 75 percent of the circumference of a top rim of the feeding bowl thus providing an opening for an animal to access the feeding bowl cavity,
wherein the shield extends to a height of about 12 inches from the floor, and
wherein the shield flares outwardly from the feeding bowl cavity as it extends upwardly in the range of about 1 to 30 degrees and is configured to allow an animal to push food up an inside wall of the shield so that it can slide into its mouth when it opens its mouth.

8. The feeding vessel assembly of claim 1 or 6, further comprising a disposable liner configured to line the interior cavity of the feeding bowl.
